(19) United States
(12) Patent Application Publication
(10) Pub. No.: US 2026/0171511 A1
(43) Pub. Date: Jun. 18, 2026

(54) LITHIUM-ION BATTERY ADDITIVES

(71) Applicant: FORD GLOBAL TECHNOLOGIES, LLC, Dearborn, MI (US)

(72) Inventors: Minghong LIU, Canton, MI (US); Wei XU, Livonia, MI (US); Jiyun PARK, Troy, MI (US); Sathish RAJENDRAN, Farmington Hills, MI (US)

(21) Appl. No.: 18/982,891

(22) Filed: Dec. 16, 2024

(51) Int. Cl. H01M 10/42; H01M 4/04; H01M 4/62; H01M 10/0525; H01M 10/0569

(52) U.S. Cl. CPC H01M 10/4235; H01M 4/0404; H01M 4/0419; H01M 4/043; H01M 4/62; H01M 10/0525; H01M 10/0569; H01M 2300/0028

(57) ABSTRACT

A lithium-ion battery cell is presented. The lithium-ion battery cell includes a current collector and an active material layered thereon. The active material layer includes an electrode active material, a conductive agent, and a binder, with a bottom adjacent to the current collector containing a solid electrolyte. The battery cell further includes a liquid electrolyte that permeates the active material layer, increasing ion transport through interaction with the solid electrolyte during cycling.

### TECHNICAL FIELD

The disclosure relates to electrode additive materials for lithium-ion batteries.

### BACKGROUND

Microscopic observations of lithium-ion battery anode cross-sections indicate that lithiation during charging and discharging may vary along the depth of the electrode. The lower layer of the anode may remain less lithiated, while the top layer may have a higher degree of lithiation. This variation in lithiation behavior may lead to differences in local potential within the anode.

### SUMMARY

An electrode includes a current collector, an active material layered on the current collector, containing an electrode active material, conductive agent, and binder, and having a bottom adjacent to the current collector containing solid electrolyte, and a liquid electrolyte permeating the active material layer and configured to increase ion transport with the solid electrolyte during cycling of the electrode. The current collector may be copper-based. The solid electrolyte may be a sulfide-based material. The solid electrolyte may be an oxide-based material. The solid electrolyte may be a halide-based material. The solid electrolyte may be less than 10 wt. % of the electrode. The liquid electrolyte may be a carbonate-based electrolyte. The active material may be graphite-based.

A method of manufacturing an electrode includes depositing a bottom layer of electrode active material, conductive agent, binder, and solid electrolyte onto a current collector, depositing a top layer of electrode active material, conductive agent, and binder, onto the bottom layer, and permeating the layers with a liquid electrolyte to facilitate ion transport with the solid electrolyte during cycling of the electrode. The solid electrolyte may be sulfides, oxides, or halides. The top layer may be deposited using a spray-coating technique. The deposited layers may be dried before permeating with the liquid electrolyte. The liquid electrolyte may be a mixture of ethylene carbonate and diethyl carbonate. The layers may be pressed after deposition. The electrode may include less than 10 wt. % solid electrolyte.

A lithium-ion battery cell includes a positive electrode assembly, a negative electrode assembly layered on a current collector, containing an electrode active material, conductive agent, and binder, and having a bottom adjacent to the current collector containing solid electrolyte, and a liquid electrolyte permeating both electrode assemblies. The solid electrolyte is configured to increase local lithium ion presence in the negative electrode assembly during successive cycles of the lithium-ion battery cell. The solid electrolyte in the bottom layer of the negative electrode assembly may be less than 10 wt. % of the lithium-ion battery cell. The solid electrolyte in the bottom layer of the negative electrode assembly may be an oxide. The solid electrolyte in the bottom layer of the negative electrode assembly may be a halide-based material.

### BRIEF DESCRIPTION OF THE DRAWINGS

FIG. 1 is an optical microscope image of a lithium-ion battery anode cross-section;

FIG. 2 is a schematic diagram of a lithium-ion battery cell; and

FIG. 3 is a flow diagram of a method for manufacturing a lithium-ion battery electrode.

### DETAILED DESCRIPTION

Detailed embodiments of the present invention are described herein to provide a thorough understanding of its implementation and functionality. However, these embodiments are presented as examples and are not intended to limit the invention, which may encompass various alternative configurations and materials. For instance, the use of solid electrolyte particles in the lower layers of the negative active material layer adjacent to the current collector, as described herein, may involve variations in the type of solid electrolyte material, such as sulfides, oxides, halides, or polymers, and their specific integration methods. The figures included in this disclosure are schematic representations and are not necessarily to scale; features may be exaggerated or minimized to emphasize details of particular components. Specific structural and functional details disclosed herein, such as the incorporation of less than 10 wt. % solid electrolyte particles or the use of liquid electrolyte saturating both electrode assemblies, are not to be interpreted as limiting but rather as a representative basis for teaching one skilled in the art how to implement and adapt the present invention in various ways.

Unless explicitly stated otherwise, all numerical values and ranges provided in this disclosure—such as those relating to quantities, measurements, percentages, weights, and other numerical references—are to be interpreted as approximate. This applies even when the term “about” is not explicitly used. For example, if a bottom layer is described as containing “less than 10 wt. % solid electrolyte,” this encompasses slight variations due to material properties, manufacturing tolerances, or intended functionality. Similarly, when a range such as “100 to 200 units” is described, it should be interpreted as “approximately 100 to approximately 200 units,” accounting for practical variability. These principles apply to disclosed values such as the weight percentages of the solid electrolyte, the ratio of active materials, and the ionic conductivity enhancements achieved through the use of liquid electrolyte interacting with solid electrolyte particles. These inherent variations are considered within the scope of the invention, as they accommodate the practical realities of manufacturing processes and material behavior described herein.

For lithium-ion batteries in electric vehicles, the ability to rapidly recharge is a factor in consumer acceptance. High-energy-density batteries, often designed with thick anode electrodes to maximize energy storage, may face challenges during fast-charging. During charging and discharging cycles, lithium-ion (Li⁺) distribution within the anode may become uneven, leading to incomplete lithiation of the lower layers while the upper layers achieve full lithiation. This imbalance may create localized regions of high overpotentials in the top layers of the anode, particularly during high-current fast-charging. In certain conditions, these overpotentials may fall below the lithium plating threshold, triggering lithium deposition on the electrode surface.

Semi-solid-state batteries have been developed incorporating high proportions of solid-state electrolytes (SSE) in the electrode active material layer. These layers include an electrode active material, conductive agent, binder, and a composite electrolyte that may include oxide SSEs, polymer electrolytes formed via in situ polymerization, and/or liquid electrolytes. Polymer and liquid electrolytes increase contact between the active material and the SSE, thereby lowering impedance and increasing the electrochemical properties of the electrode.

Despite these advantages, semi-solid-state batteries face limitations, particularly in terms of energy density. Solid electrolytes are relatively dense materials, and their high proportion within the electrode reduces the overall energy density compared to conventional lithium-ion batteries. Additionally, the use of polymer and solid electrolytes may introduce complexities related to contact resistance and the need for precise manufacturing conditions.

The present disclosure increases lithiation uniformity within an anode by integrating small amounts (<10 wt. %) relative to an overall battery cell of solid electrolyte additives into the lower layers of the anode electrode, adjacent to the current collector. This configuration maintains stable ion transport and prevents localized overpotential conditions. These additives, which may include sulfides, oxides, polymers, or halides, increase the local Li⁺ presence in regions prone to ion depletion under high current charging. This localized expansion in ion availability mitigates the effects of Li⁺ gradients, reducing the likelihood of overpotential-induced lithium plating and dendrite formation.

Each category of solid electrolyte additive may offer distinct advantages. Sulfides, for example, exhibit high ionic conductivity and flexibility, enabling efficient ion transport at the interface between the additive and the anode material. Examples of sulfides include lithium thiophosphates, such as Li₁₀GeP₂S₁₂, and related materials. Oxide-based solid electrolytes, such as lithium garnets or perovskite oxides, have high chemical stability and thermal resistance, making them suitable for long-term operation under demanding conditions. Polymer-based additives, including polyethylene oxide or cross-linked polymer matrices, increase electrode flexibility while maintaining compatibility with liquid electrolytes, effectively reducing interface impedance. Halide solid electrolytes, such as lithium chlorides or bromides, provide a lower density compared to other solid electrolytes and facilitate integration with conventional liquid electrolytes while maintaining ionic conductivity. By adjusting the composition and proportion of these additives, the presented configurations may maintain uniform lithiation throughout the anode.

Unlike semi-solid-state batteries, the electrode configuration proposed does not rely on polymer electrolytes or high proportions of solid electrolytes. By maintaining the liquid electrolyte content at levels similar to conventional lithium-ion batteries, the proposed configuration prevents high contact resistance issues associated with solid-state interfaces. This maintains consistent electrochemical performance of the battery.

Furthermore, the low proportion of solid electrolyte additives also maintains comparable energy density to that of conventional lithium-ion batteries. This contrasts with semi-solid-state designs, where the high density of solid electrolyte materials may affect the energy density.

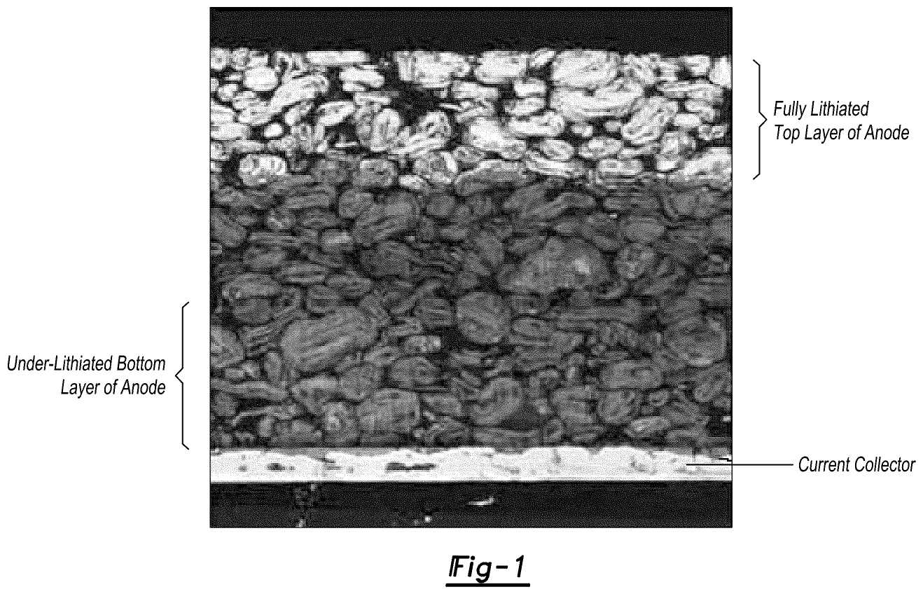

FIG. 1 is an optical microscope cross-section of a lithium-ion battery anode during charging and discharging cycles. The cross-section shows disparity in lithiation across the depth of the anode. Specifically, the lower layer of the anode, adjacent to the current collector is significantly under-lithiated or remains entirely un-lithiated. In contrast, the upper layer of the anode, closer to the separator, is fully lithiated. This non-uniform lithiation distribution is evident from the visible differences in material texture and coloration, which correlate with the degree of lithiation.

The imbalance in lithiation between the lower and upper layers of the anode may lead to electrochemical challenges. The top layer of the anode, which is heavily lithiated, may experience localized high overpotentials due to the uneven ion distribution. Under certain conditions, these overpotentials may drop below the lithium plating potential, initiating lithium plating on the electrode surface. Prolonged lithium plating increases the likelihood of dendrite formation.

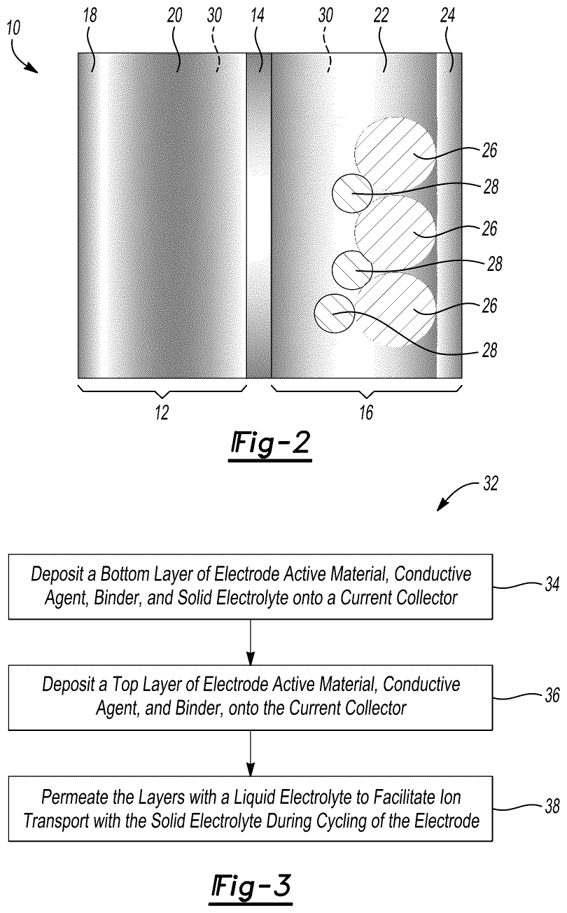

FIG. 2 is a schematic diagram of a lithium-ion battery cell 10. The lithium-ion battery cell 10 includes a positive electrode assembly 12, a separator 14, and a negative electrode assembly 16. The positive electrode assembly 12 includes a current collector 18 and a positive active material layer 20. The current collector 18 may be a conductive metal such as aluminum, chosen for its lightweight properties, high electrical conductivity, and compatibility with the positive active material layer 20. The positive active material layer 20 may include active materials such as lithium nickel cobalt manganese oxide, lithium iron phosphate, or lithium cobalt oxide. The positive active material layer 20 may also contains conductive agents, such as carbon black, and polymeric binders to maintain mechanical integrity and electrical connectivity.

The separator 14 is a thin, porous, and electrically insulating membrane positioned between the positive and negative electrode assemblies 12 and 16 to prevent direct contact therebetween while allowing Li⁺ transport. The separator 14 may be made of polyethylene or polypropylene, and may further include a ceramic coating to increase thermal stability and electrolyte wettability.

The negative electrode assembly 16 includes a negative active material layer 22 and a negative current collector 24. The negative current collector 24 may be made of copper, which offers electrical conductivity and compatibility with the negative active material layer 22. The negative active material layer 22 includes a mixture of negative active material particles 26 and solid electrolyte particles 28, which are mainly present in the lower layers of the negative active material layer 22 near the negative current collector 24. Directing the solid electrolyte particles 28 near the lower layers mitigates lithiation imbalances by increasing the Li+ concentation closer to the current collector 24. The negative active material particles 26 may include graphite, lithium titanate, or silicon-based composites. These materials serve as hosts for Li⁺ intercalation and deintercalation during charging and discharging cycles. The positive and the negative active material assemblies 12 and 16 may contain binder material to increase mechanical stability and adhesion between layers and between the current collector 14.

The solid electrolyte particles 28 are integrated near the bottom of the negative active material layer 22 in small amounts, constituting less than 10 wt. % of the lithium-ion battery cell 10. The solid electrolyte particles 28 particles increase local Li⁺ presence and ion conductivity, particularly in regions prone to Li⁺ depletion. The solid electrolyte particles 28 may include sulfides such as Li₁₀GeP₂S₁₂ or Li₆PS₅Cl, oxides such as Li₇La₃Zr₂O₁₂ or perovskite oxides, polymers such as polyethylene oxide or polyacrylonitrile-based composites, or halides such as lithium chlorides or bromides.

The lithium-ion battery cell 10 may further include a liquid electrolyte 30 saturating both the positive electrode assembly 12 and the negative electrode assembly 16. The liquid electrolyte 30 facilitates ion transport between the electrode assemblies through the separator 14 and interacts with the solid electrolyte particles 28 in the negative active material layer 22 to increase local lithium-ion concentration during cycling. The liquid electrolyte 30 may be carbonate-based solvents, such as ethylene carbonate and diethyl carbonate, mixed with a lithium salt, such as lithium hexafluorophosphate.

FIG. 3 is a flowchart of a method 32 for manufacturing a lithium-ion battery electrode. Step 34 begins with depositing a bottom layer comprising electrode active material, conductive agent, binder, and solid electrolyte onto a current collector. In step 36 a top layer of electrode active material, conductive agent, and binder is then deposited onto the current collector and the bottom layer. Step 36 may utilize a spray-coating technique, for uniformity and integration with the underlying layer. In step 38 once the layers are deposited, they are permeated with a liquid electrolyte to facilitate ion transport and interaction with the solid electrolyte. Before step 38, the layers may be dried to remove residual solvents, ensuring efficient electrolyte infiltration. The layers may further undergo pressing after deposition to increase mechanical stability and contact between the materials.

While the above description provides exemplary embodiments of the invention, it is not intended to encompass all possible variations or configurations. The terminology used in this specification serves to describe, rather than limit, the scope of the invention. It is understood that modifications and adaptations, such as variations in the type or proportion of solid electrolytes, electrode structures, or manufacturing techniques, may be made without departing from the spirit and scope of the invention. Furthermore, individual features described in different embodiments may be combined or reconfigured to create additional implementations consistent with the principles disclosed herein.

What is claimed is:

1. An electrode comprising:
a current collector;
an active material layered on the current collector, containing an electrode active material, conductive agent, and binder, and having a bottom adjacent to the current collector including solid electrolyte; and
a liquid electrolyte permeating the active material and configured to facilitate ion transport with the solid electrolyte during cycling of the electrode.

2. The electrode of claim 1 wherein the current collector is copper-based.

3. The electrode of claim 1 wherein the solid electrolyte is a sulfide-based material.

4. The electrode of claim 1 wherein the solid electrolyte is an oxide-based material.

5. The electrode of claim 1 wherein the solid electrolyte is a halide-based material.

6. The electrode of claim 1 wherein the solid electrolyte is less than 10 wt. % of the electrode.

7. The electrode of claim 1 wherein the liquid electrolyte is a carbonate-based electrolyte.

8. The electrode of claim 1 wherein the active material is graphite-based.

9. A method of manufacturing an electrode comprising:
depositing a bottom layer of electrode active material, conductive agent, binder, and solid electrolyte onto a current collector;
depositing a top layer of electrode active material, conductive agent, and binder, onto the bottom layer; and
permeating the layers with a liquid electrolyte.

10. The method of claim 9 wherein the solid electrolyte includes sulfides, oxides, or halides.

11. The method of claim 9 wherein the top layer is deposited using a spray-coating technique.

12. The method of claim 9, further comprising drying the deposited layers before the permeating.

13. The method of claim 9 wherein the liquid electrolyte is a mixture of ethylene carbonate and diethyl carbonate.

14. The method of claim 9, further comprising pressing the layers after deposition.

15. The method of claim 9 wherein the electrode includes less than 10 wt. % solid electrolyte.

16. A lithium-ion battery cell comprising:
a positive electrode assembly;
a negative electrode assembly layered on a current collector, containing an electrode active material, conductive agent, and binder, and having a bottom adjacent to the current collector containing solid electrolyte; and
a liquid electrolyte permeating both the electrode assemblies and configured to increase local lithium ion presence with the solid electrolyte in the negative electrode assembly during successive cycles of the lithium-ion battery cell.

17. The lithium-ion battery cell of claim 16 wherein the solid electrolyte in the bottom of the negative electrode assembly is less than 10 wt. % of the lithium-ion battery cell.

18. The lithium-ion battery cell of claim 16 wherein the solid electrolyte in the bottom of the negative electrode assembly is an oxide-based material.

19. The lithium-ion battery cell of claim 16 wherein the solid electrolyte in the bottom of the negative electrode assembly is a halide-based material.
